(19) United States
(12) Patent Application Publication
(10) Pub. No.: US 2020/0329730 A1
(43) Pub. Date: Oct. 22, 2020

(54) FROZEN CONSUMABLE PRODUCTS CONTAINING A CANNABINOID

(71) Applicant: American Alliance for Alternative and Natural Medicine, LLC., Augusta, GA (US)

(72) Inventor: Babak BABAN, Augusta, GA (US)

(73) Assignee: American Alliance for Alternative and Natural Medicine, LLC., Augusta, GA (US)

(21) Appl. No.: 16/851,436

(22) Filed: Apr. 17, 2020

Related U.S. Application Data
(60) Provisional application No. 62/836,139, filed on Apr. 19, 2019.

(51) Int. Cl. A23G 3/48; A23L 33/20; A23L 33/135; A23L 29/00; A23L 33/105

(52) U.S. Cl. CPC A23G 3/48; A23L 33/20; A23L 33/105; A23L 29/035; A23L 33/135

(57) ABSTRACT

Disclosed herein are frozen consumable products containing a cannabinoid. The consumable products disclosed herein can be formulated as frozen desserts or as shelf-stable compositions that can be frozen prior to consumption. The consumable products contain live, active cultures of probiotic microorganisms or may contain spores of probiotic microorganisms. The consumable products have anti-inflammatory effects due to the presence of the cannabinoid but are non-narcotic. Further, the consumable products serve to enhance gut health due to the presence of probiotics. The consumable products are particularly useful for reducing the gastrointestinal side effects of chemotherapy.

### CROSS REFERENCE TO RELATED APPLICATIONS

This application claims priority upon U.S. provisional application Ser. No. 62/836,139 filed on Apr. 19, 2019. This application is hereby incorporated by reference in its entirety for all of its teachings.

### BACKGROUND

Mammals are hosts to several hundred different species of gut microorganisms, including bacteria, archaea, yeasts, and protozoa. Due to poor diet, medical treatments such as antibiotic use, and even stress or emotional factors, disruptions to the gut microbiota (known as “dysbiosis”) are increasingly common. Symptoms of dysbiosis range from gastrointestinal upset ranging from gas, bloating, and flatulence to indigestion or incomplete digestion, diarrhea, and constipation, fatigue, amenorrhea, iron deficiency, rosacea and adult acne, poor growth, brittleness, and weakness of the hair and nails, and more. Dysbiosis can be present in or on any part of the body but can be particularly problematic in the oral cavity and/or gastrointestinal tract.

Meanwhile, inflammation is part of the body's immune response and can be beneficial in response to an injury. In fact, the inflammatory response is required for wound healing and repairing damage to tissue. However, chronic inflammation (i.e., in the absence of any acute stimulus including, but not limited to, a wound or cut, a crush injury, a broken bone, and the like.) is increasingly a problem in modem society and has been linked to autoimmune disorders such as rheumatoid arthritis, gum disease or periodontitis, diseases of the circulatory system including atherosclerosis, allergic conditions such as hay fever, diabetes, and inflammatory bowel diseases such as ulcerative colitis and Crohn's disease. Interest in controlling inflammation is growing in both the medical community and the general population.

Dysbiosis and inflammation may be particularly problematic for individuals undergoing treatment for cancer due to immunosuppressant effects of chemotherapeutic agents. Chemotherapy patients also tend to experience side effects ranging from nausea, vomiting, and inappetance to constipation or diarrhea.

It would be advantageous to have a single consumable product to address both dysbiosis and inflammation as well as the side effects of chemotherapy. Further, it would be advantageous for the consumable product to have a pleasing taste so that the subject is encouraged to consume it on a routine basis, for maximum reduction of inflammation and cancer treatment side effects as well as to maintain an optimal level of gut health.

### SUMMARY

Disclosed herein are frozen consumable products containing a cannabinoid. The consumable products disclosed herein can be formulated as frozen desserts or as shelf-stable compositions that can be frozen prior to consumption. The consumable products contain live, active cultures of probiotic microorganisms or may contain spores of probiotic microorganisms. The consumable products have anti-inflammatory effects due to the presence of the cannabinoid but are non-narcotic. Further, the consumable products serve to enhance gut health due to the presence of probiotics. The consumable products are particularly useful for reducing the gastrointestinal side effects of chemotherapy.

The advantages of the invention will be set forth in part in the description that follows, and in part will be obvious from the description, or may be learned by practice of the aspects described below. The advantages described below will be realized and attained by means of the elements and combinations particularly pointed out in the appended claims. It is to be understood that both the foregoing general description and the following detailed description are exemplary and explanatory only and are not restrictive.

### DETAILED DESCRIPTION

Before the present compounds, compositions, and/or methods are disclosed and described, it is to be understood that the aspects described below are not limited to specific compounds, synthetic methods, or uses as such may, of course, vary. It is also to be understood that the terminology used herein is for the purpose of describing particular aspects only and is not intended to be limiting.

In this specification and in the claims that follow, reference will be made to a number of terms that shall be defined to have the following meanings:

It must be noted that, as used in the specification and the appended claims, the singular forms “a,” “an,” and “the” include plural referents unless the context clearly dictates otherwise. Thus, for example, reference to “a natural sweetener” includes mixtures of two or more such sweeteners, and the like.

Throughout this specification, unless the context dictates otherwise, the word “comprise,” or variations such as “comprises” or “comprising,” will be understood to imply the inclusion of a stated element, integer, step, or group of elements, integers, or steps, but not the exclusion of any other element, integer, step, or group of elements, integers, or steps.

“Optional” or “optionally” means that the subsequently described event or circumstance can or cannot occur, and that the description includes instances where the event or circumstance occurs and instances where it does not. For example, the phrase “optionally includes a natural flavor” means that the natural flavor may or may not be present.

As used herein, a plurality of items, structural elements, compositional elements, and/or materials may be presented in a common list for convenience. However, these lists should be construed as though each member of the list is individually identified as a separate and unique member. Thus, no individual member of any such list should be construed as a de facto equivalent of any other member of the same list based solely on its presentation in a common group, without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range was explicitly recited. As an example, a numerical range of “about 1” to “about 5” should be interpreted to include not only the explicitly recited values of about 1 to about 5, but also to include individual values and sub-ranges within the indicated range. Thus, included in this numerical range are individual values such as 2, 3, and 4, the sub-ranges such as from 1-3, from 2-4, from 3-5, from about 1-about 3, from 1 to about 3, from about 1 to 3, etc., as well as 1, 2, 3, 4, and 5, individually. The same principle applies to ranges reciting only one numerical value as a minimum or maximum.

Furthermore, such an interpretation should apply regardless of the breadth or range of the characters being described.

References in the specification and concluding claims to parts by weight, of a particular element or component in a composition or article, denote the weight relationship between the element or component and any other elements or components in the composition or article for which a part by weight is expressed. Thus, in a composition containing 2 parts by weight of component X and 5 parts by weight of component Y, X and Y are present at a weight ratio of 2:5, and are present in such ratio regardless of whether additional components are contained in the composition.

A weight percent of a component, unless specifically stated to the contrary, is based on the total weight of the formulation or composition in which the component is included.

Disclosed are materials and components that can be used for, can be used in conjunction with, can be used in preparation for, or are products of the disclosed compositions and methods. These and other materials are disclosed herein, and it is understood that when combinations, subsets, interactions, groups, etc. of these materials are disclosed, that while specific reference to each various individual combination and permutation of these compounds may not be explicitly disclosed, each is specifically contemplated and described herein. For example, if an alkali metal oxide additive is disclosed and discussed, and a number of different alkaline earth metal oxide additives are discussed, each and every combination of alkali metal oxide additive and alkaline earth metal oxide additive that is possible is specifically contemplated unless specifically indicated to the contrary. For example, if a class of alkali metal oxides A, B, and C is disclosed, as well as a class of alkaline earth metal oxide additives D, E, and F, and an example combination of A+D is disclosed, then even if each is not individually recited, each is individually and collectively contemplated. Thus, in this example, each of the combinations A+E, A+F, B+D, B+E, B+F, C+D, C+E, and C+F is specifically contemplated and should be considered from disclosure of A, B, ad C; D, E, and F; and the example combination A+D. Likewise, any subset or combination of these is also specifically contemplated and disclosed. Thus, for example, the sub-group of A+E, B+F, and C+E is specifically contemplated and should be considered from disclosure of A, B, and C; D, E, and F; and the example combination of A+D. This concept applies to all aspects of the disclosure including, but not limited to, steps in methods of making and using the disclosed compositions. Thus, if there are a variety of additional steps that can be performed with any specific embodiment or combination of embodiments of the disclosed methods, each such composition is specifically contemplated and should be considered disclosed.

The term “frozen consumable product” as used herein is defined as a food article that is a solid at or below 0° C. that is safe to be consumed by a subject.

The term “treat” as used herein is defined as maintaining or reducing the symptoms of a pre-existing condition (e.g., inflammation) when compared to not consuming the consumable product. The term “prevent” as used herein is defined as eliminating or reducing the likelihood of the occurrence of one or more symptoms of a disease or disorder when compared to not consuming the consumable product. The term “reduce” as used herein is defined as decreasing the severity of one or more symptoms (e.g., reducing the side effects of a cancer treatment, which would lead to greater patient comfort) when compared to not consuming the consumable product.

Described herein are frozen consumable products comprising (a) a cannabinoid, (b) a probiotic, and (c) ginger or ginger extract, as well as other optional components. Each component used to produce the consumable products described herein and methods for producing and using the same are described below.

In one aspect, described herein are frozen consumable products with a pleasant flavor and texture. In a further aspect, the flavor and texture may be useful in enhancing patient consumption of the products and/or compliance with a treatment regimen that includes the products.

In one aspect, the frozen consumable product is a milk-based such as, for example, frozen yogurt or ice cream. In another aspect, the frozen food is water-based (i.e., composed primarily of water) product such as a juice bar. In a further aspect, the frozen consumable product is frozen ice. Examples of frozen ice products include, but are not limited to, Popsicle®, chihiro, freeze ice, freezer pop, thrill, ice lollipop, ice lolly, ice pole, ice pop, paleta, picolé, ice block, or boli. Further in this aspect, the consumable products can be purchased by the subject in an already-frozen state. In an alternative aspect, the consumable products are shelf-stable liquids or slurries in sealed packages that are sold at room temperature and placed in the freezer by the subject prior to consumption.

The consumable product can be prepared in any weight as desired. In one aspect, the serving size of the consumable product is from 1 ounce to 10 ounces. In another aspect, the serving size of the consumable product is 1, 2, 3, 4, 5, 6, 7, 8, 9, or 10 ounces, where any value can be a lower and upper end-point of a range (e.g., 2 ounces to 9 ounces, 3 ounces to 9 ounces, etc.).

### Cannabinoid

The consumable products described herein contain one or more cannabinoids. Cannabinoids are a class of molecules produced by cannabis plants; over one hundred of these have been identified thus far. The three most abundant cannabinoids include cannabidiol (CBD), tetrahydrocannabinol (THC), and cannabinodiol (CBND). Although some cannabinoids, such as THC, are psychoactive, others (i.e., CBD) are not. In one aspect, the cannabinoid includes tetrahydrocannabinol, tetrahydrocannabinolic acid, cannabidiol, cannabidiolic acid, cannabinol, cannabigerol, cannabichromene, cannabicyclol, cannabivarin, tetrahydrocannabivarin, cannabidivarin, cannabichromevarin, cannabigerovarin, cannabigerol monomethyl ether, cannabielsoin, cannabicitran, or any combination thereof. In another aspect, the cannabinoid is cannabidiol.

In one aspect, the consumable product has from 10 to 30 mg of cannabinoid per 1 ounce to 10 ounces of consumable product. In another aspect, the consumable product has about 10, 12, 14, 16, 18, 20, 22, 24, 26, 28, or 30 mg of cannabinoid per 1 ounce to 10 ounces of consumable product, where any value can be a lower and upper end-point of a range (e.g., 12 to 28 mg, 15 to 25 mg, etc.). In one aspect, the consumable product has about 20 mg of cannabidiol (CBD) per 1 ounce to 10 ounces of consumable product.

### Probiotic

The consumable products disclosed herein include a probiotic. In one aspect, the probiotic is a live microorganism that can colonize in the digestive system. In another aspect, the probiotic is a microbial spore that is shelf stable in aqueous solution and can survive the harsh environment of the upper gastrointestinal tract in order to establish a population in the gut.

In one aspect, the probiotic is a yeast such as, for example, an organism selected from the genus Saccharomyces, Debaromyces, Candida, Pichia, or Torulopsis. In an alternative aspect, the probiotic is a mold such as, for example, an organism selected from the genus Aspergillus, Rhizopus, Mucor, or Penicillium. In still another aspect, the probiotic is a bacterium such as, for example, an organism selected from the genus Bifidobacterium, Bacterioides, Clostridium, Fusobacterium, Melissococcus, Propionibacterium, Streptococcus, Enterococcus, Lactococcus, Kocuria, Staphylococcus, Peptostreptococcus, Bacillus, Pediococcus, Micrococcus, Euconostoc, Weissella, Aerococcus, Oenococcus, or Lactobacillus. In still another aspect, the probiotic is a combination of organisms from one or more of the genera listed above.

In another aspect, the probiotic is Aspergillus niger, A. oryzae, Bacillus coagulans, B. lentus, B. licheniformis, B. mesentericus, B. pumilus, B. subtilis, B. natto, Bacteroides amylophilus, Bac. capillosus, Bac. ruminocola, Bac. suis, Bifidobacterium adolescentis, Bif. animalis, Bif. breve, Bif. bifidum, Bif. infantis, Bif. lactis, Bif. longum, Bif. pseudolongum, Bif. thermophilum, Candida pintolepesii, Clostridium butyricum, Enterococcus cremoris, E. diacetylactis, E. faecium, E. intermedius, E. lactis, E. mundtii, E. thermophilus, Escherichia coli, Kluyveromyces fragilis, Lactobacillus acidophilus, L. alimentarius, L. amylovorus, L. crispatus, L. bifidus, L. brevis, L. bulgaricus, L. casei, L. curvatus, L. cellobiosus, L. delbrueckii ss. bulgaricus, L. farciminis, L. fermentum, L. gasseri, L. helveticus, L. lactis, L. plantarum, L. johnsonii, L. paracasei, L. reuteri, L. rhamnosus, L. sakei, L. salivarius, Leuconostoc mesenteroides, Pediococcus cereviseae (damnosus), P. acidlactici, P. pentosaceus, Propionibacterium freudenreichii, Prop. shertnanii, Saccharomyces cereviseae, Staphyloccus carnosus, Staph. xylosus, Streptococcus infantarius, Strep. salivarius ss. thermophilus, Strep. thermophilus, Strep. lactis, or any combination thereof.

In one aspect, the probiotic is a combination of Streptococcus thermophilus, Bacillus coagulans, Bifidobacterium breve, Bifidobacterium longum, Bifidobacterium infantis, Bifidobacterium lactis, Lactobacillus acidophilus, Lactobacillus plantarum, Lactobacillus paracasei, and Lactobacillus delbrueckii ss. Bulgaricus.

As used herein, a “colony forming unit” or “CFU” is a measure of how many bacteria in a sample are capable of forming colonies. In this aspect, microorganisms are cultured and only viable cells are counted as CFUs. In one aspect, it is uncertain if a given colony on a culture plate arose from one cell or a group of several cells, hence the use of CFUs to address the uncertainty.

In one aspect, the consumable product has from 100 to 600 billion colony forming units (CFUs) of probiotic organisms per 1 ounce to 10 ounces of consumable product. In a further aspect, the consumable product can have about 100, 150, 200, 250, 300, 350, 400, 450, 500, 550, 600, 650, 700, 750, 800, 850, or 900 billion CFUs per 1 ounce to 10 ounces of consumable product, where any value can be a lower and upper end-point of a range (e.g., 200 billion to 800 billion CFU, 400 billion to 600 billion CFU, etc.). In one aspect, all of the CFUs are from the same organism. In an alternative aspect, the CFUs are from a mixture of organisms. In one aspect, the consumable product has about 450 billion CFUs per 1 ounce to 10 ounces of consumable product and the CFUs are from a mixture of organisms.

In one aspect, the probiotic can be useful for treating or preventing dysbiosis, for re-establishing and maintaining a healthy microbiome in the oral cavity and/or the gastrointestinal tract, for reducing inflammation, and/or for treating or preventing chemotherapy-induced ulcers.

### Ginger or Ginger Extract

In one aspect, the consumable products disclosed herein include ginger or a ginger extract. Ginger is a historical herbal remedy for nausea and upset stomach. In one aspect, ginger functions in the consumable products disclosed herein to reduce nausea associated with chemotherapy. In another aspect, the ginger can reduce nausea from causes not associated with chemotherapy, as well. In some aspects, ginger or ginger extract also contributes to the flavor of the consumable products.

In one aspect, the consumable products have from 0.1 to 5 grams of ginger or ginger extract per 1 ounce to 10 ounces of consumable product. In another aspect, the consumable products have about 0.1, 0.5, 0.75, 1, 1.25, 1.5, 1.75, 2, 2.25, 2.5, 2.75, 3.0, 3.25, 3.5, 3.75, 4.0, 4.25, 4.5, 4.75, or 5 grams of ginger or ginger extract per 1 ounce to 10 ounces of consumable product. In one aspect, the consumable products 1.5 grams of ginger or ginger extract per 1 ounce to 10 ounces of consumable product, where any value can be a lower and upper end-point of a range (e.g., 0.5 to 3 grams, 1 to 2 grams, etc.). In one aspect, the consumable product has about 1.5 grams of ginger or ginger extract per 1 ounce to 10 ounces of consumable product.

Fruit Juice, Fruit Juice Concentrate, Fruit Pulp, and/or Fruit Puree

In certain aspects, a juice, fruit juice concentrate, fruit pulp, fruit puree, or any combination thereof can be used to produce the frozen consumable products described herein. As used herein, “fruit juice” is a liquid made by extracting or pressing the natural liquid from a fruit. “Fruit juice concentrate” as used herein refers to fruit juice wherein some or all of the excess water contained in fruit juice has been removed. Meanwhile, “fruit pulp” refers to the part of a fruit that remains following the extraction or pressing of juice. Fruit pulp may be sourced from the endocarp or mesocarp or any fleshy part of a fruit, depending on the anatomy of the fruit. Finally, “fruit puree” is when edible parts of a fruit are pressed, blended, or otherwise processed until they have the consistency of a paste or liquid. In some aspects, a fruit puree may contain added water or juice for processing purposes. In other aspects, a fruit puree contains no added liquids.

In one aspect, the fruit juice, fruit juice concentrate, fruit pulp, and/or fruit puree can be sourced from apples, pears, oranges, clementines, blood oranges, pomegranates, currants, tangerines, bananas, grapes, pineapples, raspberries, blueberries, cherries, blackberries, strawberries, watermelon, cantaloupe, honeydew melon, lychees, figs, dates, limes, lemons, coconuts, mangoes, guavas, papayas, passionfruits, dragonfruits, apricots, plums, peaches, nectarines, plumcots, kiwis, acai berries, and combinations thereof. In a further aspect, highly colored fruits may provide natural colors to the consumable products. In another aspect, the fruits may provide a tart taste or a sweet taste (i.e., due to the presence of natural sugars). In still another aspect, the fruits may contribute to texture or mouth feel (e.g., due to the presence of pectin in apples, etc.).

The amount of fruit juice, fruit juice concentrate, fruit pulp, or fruit puree that be incorporated into the consumable product can vary depending upon the desired taste of the product.

### Prebiotics

In another aspect, the consumable product further contains a prebiotic. As used herein, “prebiotic” refers to a food ingredient that promotes the growth of beneficial microorganisms (such as, for example, microorganisms consumed as probiotics) in the intestine. In one aspect, the prebiotic can be an inulin or can be maltodextrin, or a combination thereof. In one aspect, the maltodextrin, when included, is a non-GMO digestion-resistant maltodextrin.

In one aspect, the prebiotic can be a fiber. In one aspect, the prebiotic is a fiber derived from acacia gum or gum arabic, raw dandelion greens, raw leeks, Jerusalem artichokes, raw jicama, underripe bananas, raw chicory root, raw garlic, onions, agave nectar, raw wheat bran, whole wheat flour, yacon, Echinacea, burdock, globe artichoke, wild yam, mugwort, or raw asparagus. In one aspect, the prebiotic is or contains an inulin. In another aspect, the prebiotic can be a “galactooligosaccharide” or “GOS.” Using techniques known in the art, the fiber can be separated and isolated from the natural sources listed above.

As used herein, “inulin” refers to a naturally occurring polysaccharide produced by a plant such as, for example, chicory. An inulin is a type of dietary fiber and is classified as a “fructan” or a polymer of fructose. A “fructooligosaccharide” or “FOS” or “oligofructose” is a fructan with a short chain length. As an example, the degree of polymerization in inulin can be from 10 to 60, or in some instances, can be up to several thousand fructose units, whereas the degree of polymerization in FOS produced from the chemical degradation of inulin can be from 1 to 14 or from 1 to 7. FOS may improve the flavor or odor of food products; FOS is often used as alternative sweeteners, but FOS, like inulin, can serve as a substrate for probiotic microorganisms in the large intestine.

In another aspect, the consumable products can contain another type of dietary fiber such as, for example, soluble fiber from oat bran, barley, nuts, seeds, beans, lentils, peas, or psyllium husk, or a combination thereof. In an alternative aspect, the consumable products contain insoluble fiber from wheat bran, vegetables, or whole grains, or a combination thereof. In still another aspect, the consumable products contain a combination of soluble and insoluble fiber.

As used herein, “maltodextrin” is a polysaccharide produced from plant starches such as, for example, corn or wheat starches. In a further aspect, in addition to acting as a prebiotic, when included in the consumable products disclosed herein, maltodextrin can alter the mouth feel of the consumable products. In a still further aspect, when included in the consumable products disclosed herein, the maltodextrin can add sweetness to the consumable products, or may remain largely flavorless.

In one aspect, the consumable products described herein are “symbiotic.” This term refers to products containing both probiotics and prebiotics and specifically to products wherein the prebiotics are chosen selectively to favor the growth of the probiotic microorganisms.

In one aspect, the consumable products contain from 1 to 20 grams of fiber and/or prebiotic per 1 ounce to 10 ounces of consumable product, or contain about 1, 2, 3, 4, 5, 6, 7, 8, 9, 10, 11, 12, 13, 14, 15, 16, 17, 18, 19, or 20 grams of prebiotic per 1 ounce to 10 ounces of consumable product, where any value can be a lower and upper end-point of a range (e.g., 1 to 15 grams, 1 to 10 grams, etc.). In one aspect, the consumable products contain 5 grams of fiber per 1 ounce to 10 ounces of consumable product.

### Protein

In one aspect, the consumable products disclosed herein include protein. In one aspect, the protein can be pea protein, hemp protein, pumpkin seed protein, brown rice protein, soy protein, sunflower seed protein, peanut protein, quinoa protein, sacha inchi protein, chia protein, whey protein, casein protein, egg protein, alfalfa protein, flax protein, artichoke protein, collagen protein, or a combination thereof. In one aspect, the protein and prebiotic (e.g., fiber) in the consumable product are sourced from the same organism (e.g., the consumable product contains protein and fiber from pumpkin seeds or hemp seeds).

In a further aspect, protein in the consumable products has one or more important functions such as, for example, providing caloric content and/or nutrition to a subject, assisting with the building and repair of tissues, contributing to the regrowth of hair that was lost or thinned during cancer treatment, and the like.

In another aspect, the consumable products contain from 1 to 20 grams of protein per 1 ounce to 10 ounces of consumable product, or contain about 1, 2, 3, 4, 5, 6, 7, 8, 9, 10, 11, 12, 13, 14, 15, 16, 17, 18, 19, or 20 grams of protein per 1 ounce to 10 ounces of consumable product, where any value can be a lower and upper end-point of a range (e.g., 2 to 18 grams, 5 to 15 grams, etc.). In one aspect, the consumable products contain about 10 grams of protein per 1 ounce to 10 ounces of consumable product.

### Natural Sweetener

A “sweetener” is a compound, extract, or composition that imparts a sweet taste to a food of beverage. Inclusion of a sweetener may assist in improving the flavor of a food or beverage product. In one aspect, the beverages disclosed herein do not contain any added sweeteners. In another aspect, the beverages disclosed herein contain one or more added sweeteners.

In one aspect, the sweetener is a natural sweetener. Examples of sweeteners useful herein include, but are not limited to, cane sugar, evaporated cane juice, beet sugar, polydextrose, coconut sugar, agave nectar, honey, maple syrup, molasses, barley malt syrup, brown rice syrup, date sugar, xylitol, erythritol, lucuma powder, monk fruit extract, stevia extract, or any combination thereof. In one aspect, the sweetener can add calories or other nutrients such as, for example, fiber to the beverages. In an alternative aspect, the sweetener is a non-caloric sweetener.

### Other Additives

In some aspects, the consumable products disclosed herein include additional ingredients known in the art. In a further aspect, the consumable products can include a vegetable juice, one or more natural flavors, a salt, a vitamin, a mineral, a natural preservative, water, chicory root fiber, fruit pectin, carrageenan, or any combination thereof. In one aspect, the consumable products are 100% natural (i.e., made with 100% natural components) with no artificial colors, dyes, preservatives, sweeteners, or the like.

In one aspect, these additional ingredients serve various purposes such as improving texture or mouth feel (i.e., chicory root fiber, fruit pectin, carrageenan, water), flavor (i.e., natural flavors, salt), nutrition (i.e., vitamins, minerals), or color (i.e., vegetable juices such as, for example, carrot juice for an orange color, spinach juice for a green color, beet juice for a red or pink color, and combinations thereof).

### Natural Preservative

A “preservative” is a compound or composition that is added to food and/or beverage products to prevent spoilage and prolong shelf life. In one aspect, a preservative can be an artificial or added preservative, such as, for example, sodium benzoate, benzoic acid, a nitrite, a sulfite, sodium sorbate, potassium sorbate, or a similar compound. In one aspect, added preservatives are not found in natural products. In another aspect, the beverages described herein do not contain any added or artificial preservatives.

In one aspect, the beverages described herein include a natural preservative. “Natural preservatives” as described herein include antioxidants such as, for example, vitamins A, C, and E (often present as “mixed tocopherols”). In another aspect, the natural preservative can be rosemary oil or rosemary leaf extract, lemon juice, lime juice, cinnamon extract, citric acid, or a combination thereof.

In one aspect, the consumable product disclosed herein includes the following components:

TABLE 1
Ingredients of Consumable Product,
Per Individual Serving

| Component | Amount | |
|---|---|---|
| Cannabidiol | 20 | mg |
| Probiotic culture^{a} | 450 | billion CFU |
| Ginger or ginger extract | 1.5 | g |
| Fiber and/or prebiotic | 5 | g |
| Protein | 10 | g |

^{a}In one example aspect, the probiotic culture consists of Bacillus coagulans, Bifidobacterium breve, Bifidobacterium longum, Bifidobacterium infantis, Bifidobacterium lactis, Lactobacillus acidophilus, Lactobacillus plantarum, Lactobacillus paracasei, and Lactobacillus delbrueckii ssp. Bulgaricus.

In a further aspect, the consumable product additionally contains natural flavors, fruit, fruit puree, fruit juice or fruit juice concentrate, and/or fruit pulp, as well as other additives and ingredients disclosed herein.

The consumable products described herein can be produced using techniques known in the art for making milk-based products (e.g., frozen yogurt, ice cream) and water-based products. The different components such as the cannabinoid, probiotic, ginger or ginger extract, etc. can be added in varying amounts during the production of the product.

### Method for Alleviating the Side Effects of Chemotherapy

In one aspect, provided herein is a method for treating, preventing, or reducing one or more side effects of chemotherapy in a subject. In a further method, the method involves consuming the consumable product described herein.

In one aspect, consumption of the products described herein is effective at reducing inflammation associated with chemotherapy or other medical treatments. In another aspect, consumption of the products described herein can reduce nausea, vomiting, or inappetance. Further in this aspect, reduction of nausea, vomiting, and/or inappetance can result in the subject's increased desire to eat, which is useful for maintaining or increasing weight, recovery from surgery or radiation treatments, and the like. In still another aspect, consumption of the products described herein can reduce the diarrhea and/or constipation that results from chemotherapy. In still another aspect, consumption of the products described herein can reduce fatigue in a subject undergoing chemotherapy.

Further in this aspect, the cold temperature of the products at the time of consumption may be soothing to irritated or inflamed oral mucosa and can assist with the production of saliva and/or the treatment of dry mouth associated with chemotherapy.

In one aspect, one serving of the consumable product should be eaten per day. In another aspect, the consumable product is safe to eat in any amount. Further in this aspect, a subject can eat one serving of the consumable product any time nausea or inappetance is experienced. In another aspect, a subject can eat one serving of the consumable product at one or more scheduled times each day, such as, for example, one hour or 30 minutes prior to a meal. In still another aspect, the consumable product is suitable as a meal replacement. In an alternative aspect, the consumable product is intended to supplement regular meals and is not a meal replacement. In one aspect, the consumable product can be consumed product prior to undergoing chemotherapy. In another aspect, the consumable product can be consumed during and/or after undergoing chemotherapy.

### Method for Reducing Inflammation

In one aspect, the consumable products described herein are useful for fighting or reducing inflammation. “Inflammation” as used herein is part of the body's response to harmful stimuli. In the instance of injury or tissue damage, inflammation is a protective response localized to a specific area (such as, for example, redness and swelling around a burn). In another aspect, inflammation can be chronic inflammation or systemic inflammation. Further in this aspect, chronic or systemic inflammation can contribute to an overall decline in the health of the body.

In one aspect, the inflammation can be produced by chemotherapy or cancer treatment. Depending upon the type of cancer that is treated and the chemotherapeutic agent selected, inflammation can result in different parts of the cancer patient.

In another aspect, the inflammation is produced by cancer present in the subject. Inflammation has been linked to several different types of cancer. In one aspect, gastrointestinal cancers such as, for example, stomach cancer, colon cancer, esophageal cancer, an intestinal cancer can produce debilitating inflammation and pain.

In another aspect, the consumable products described herein can reduce or prevent inflammation that can cause cancer. For example, Helicobacter pylori and hepatitis C virus can promote cancer development, both of which induce tumorigenesis through epithelial injury and inflammation. Consumption of the products described herein may exert some beneficial effects for cancer prevention.

In another aspect, the consumable products described herein can reduce or prevent inflammation caused by a gastrointenstinal disorder or a bowel disease. In one aspect, consumable products described herein can reduce or prevent inflammation caused by inflammatory bowel disease, ulcerative colitis, Crohn's disease of the bowel, hemorrhoids, or stress ulceration of the stomach and esophagus.

In another aspect, the consumable products described herein can reduce or prevent inflammation caused by diabetes. Examples of inflammation caused by diabetes include, but are not limited to, diabetic nephropathy, glomerulonephritis and diabetic skin ulcers.

### Method for Dysbiosis

In another aspect, consumption of the products described herein can correct or improve cases of dysbiosis. As used herein, “dysbiosis” refers to an imbalance of the microbial population on or inside the body, such as in the intestinal tract. In some aspects, when a subject is in a state of dysbiosis, pathogenic bacteria normally present in low amounts flourish. This can lead to improper digestion, malabsorption of food and/or specific nutrients, and other illnesses and conditions due to competition between pathogenic bacteria and useful bacteria such as, for example, those that produce certain vitamins (e.g., vitamin K) from dietary precursors. In another aspect, accumulation of waste products from pathogenic bacteria is another harmful effect of dysbiosis. Prolonged dysbiosis can result from inappropriate diet, antibiotic exposure, alcohol abuse, and the like. Dysbiosis in the intestinal tract is best known, but a state of dysbiosis can also be found among skin flora (leading to, for example, staph infections such as boils, impetigo, cellulitis, and staphylococcal scalded skin syndrome) and in the vagina (leading to, for example, vaginal yeast infections). In one aspect, consumption of the products described herein leads to a reduction or improvement in a case of dysbiosis. In one aspect, the dysbiosis can be a result of chemotherapy or cancer treatment. In an alternative aspect, the dysbiosis can be from another source.

### Exemplary Aspects

In a first aspect, the frozen consumable product comprises (a) a cannabinoid, (b) a probiotic, and (c) ginger or ginger extract.

In a second aspect, the consumable product of the first aspect comprises milk.

In a third aspect, the consumable product of the second aspect comprises frozen yogurt or ice cream.

In a fourth aspect, the consumable product of the first aspect further comprises fruit juice, fruit juice concentrate, fruit pulp, fruit puree, or any combination thereof.

In a fifth aspect, the consumable product of the fourth aspect further comprises a juice bar or frozen ice.

In a sixth aspect, the cannabinoid of the first to fifth aspects comprises tetrahydrocannabinol, tetrahydrocannabinolic acid, cannabidiol, cannabidiolic acid, cannabinol, cannabigerol, cannabichromene, cannabicyclol, cannabivarin, tetrahydrocannabivarin, cannabidivarin, cannabichromevarin, cannabigerovarin, cannabigerol monomethyl ether, cannabielsoin, cannabicitran, or any combination thereof.

In a seventh aspect, the cannabinoid of the sixth aspect is cannabidiol.

In an eighth aspect, the cannabinoid of the seventh aspect is present in an amount of from 15 mg to 25 mg per 1 ounce to 10 ounces of consumable product.

In a ninth aspect, the cannabinoid of the seventh aspect is present in an amount of from 10 mg to 30 mg per 1 ounce to 10 ounces of consumable product.

In a tenth aspect, the probiotic of the first to ninth aspects comprises Streptococcus thermophilus, Bacillus coagulans, Bifidobacterium breve, Bifidobacterium longum, Bifidobacterium infantis, Bifidobacterium lactis, Lactobacillus acidophilus, Lactobacillus plantarum, Lactobacillus paracasei, Lactobacillus delbrueckii subsp. bulgaricus or any combination thereof.

In an eleventh aspect, the probiotic of the first to tenth aspects is present in an amount of from 100 billion colony-forming units to 900 billion colony forming units per 1 ounce to 10 ounces of consumable product

In a twelfth aspect, the probiotic of the first to tenth aspects is present in an amount of from 500 billion colony-forming units to 600 billion colony forming units per 1 ounce to 10 ounces of consumable product.

In a thirteenth aspect, the ginger or ginger extract of the first to twelfth aspects is present in an amount of from 0.1 grams to 5 grams per 1 ounce to 10 ounces of consumable product.

In a fourteenth aspect, the ginger or ginger extract of the first to twelfth aspects is present in an amount of from 1 gram to 2 grams per 1 ounce to 10 ounces of consumable product.

In a fifteenth aspect, the consumable product of the first to fourteenth aspects further comprises a prebiotic.

In a sixteenth aspect, the prebiotic of the fifteenth aspect is a fiber from acacia gum, gum arabic, raw dandelion greens, raw leeks, Jerusalem artichokes, raw jicama, underripe bananas, raw chicory root, raw garlic, onions, agave nectar, raw wheat bran, whole wheat flour, yacon, Echinacea, burdock, globe artichoke, wild yam, mugwort, raw asparagus, inulin, oat bran, barley, nuts, seeds, beans, lentils, peas, psyllium husk, maltodextrin, corn starch, wheat starch, or any combination thereof.

In a seventeenth aspect, the prebiotic of the sixteenth aspect is present in an amount of from 1 gram to 20 grams per 1 ounce to 10 ounces of consumable product.

In an eighteenth aspect, the prebiotic of the sixteenth aspect is present in an amount of from 1 gram to 10 grams per 1 ounce to 10 ounces of consumable product.

In a nineteenth aspect, the consumable product of the first to eighteenth aspects further comprises a protein from peas, hemp, pumpkin seeds, brown rice, soy, sunflower seeds, peanuts, quinoa, sacha inchi, chia, whey, casein, egg, alfalfa, flax, artichoke, collagen, or any combination thereof.

In a twentieth aspect, the protein of the nineteenth aspect is present in an amount of from 1 gram to 20 grams per 1 ounce to 10 ounces of consumable product.

In a twenty first aspect, the protein of the nineteenth aspect is present in an amount of from 5 gram to 15 grams per 1 ounce to 10 ounces of consumable product.

In a twenty second aspect, the consumable product of the first to twenty first aspects further comprises a natural sweetener.

In a twenty third aspect, the natural sweetener of the twenty second aspect comprises cane sugar, stevia extract, polydextrose, agave nectar, maple syrup, honey, evaporated cane juice, xylitol, brown rice syrup, coconut sugar, or any combination thereof.

In a twenty fourth aspect, the consumable product of the first to twenty third aspects further comprises a vegetable juice, one or more natural flavors, a salt, a vitamin, a mineral, a natural preservative, water, chicory root fiber, fruit pectin, carrageenan, or any combination thereof.

In a twenty fifth aspect, the natural preservative of the twenty fourth aspect is vitamin E, lemon juice, lime juice, rosemary extract, or any combination thereof.

In a twenty sixth aspect, the consumable product of the first to twenty fifth aspects does not include any artificial preservatives.

In a twenty seventh aspect, the consumable product of the first aspect comprises:
a. fruit juice, fruit juice concentrate, fruit pulp, fruit puree, or any combination thereof;
b. cannabidiol in the amount of from 15 mg to 25 mg per 1 ounce to 10 ounces of consumable product;
c. a probiotic comprising Streptococcus thermophilus, Bacillus coagulans, Bifidobacterium breve, Bifidobacterium longum, Bifidobacterium infantis, Bifidobacterium lactis, Lactobacillus acidophilus, Lactobacillus plantarum, Lactobacillus paracasei, and Lactobacillus delbrueckii subsp. Bulgaricus at 500 billion colony forming units to 600 billion colony forming units per 1 ounce to 10 ounces of consumable product; and
d. ginger or ginger extract in the amount of from 1 gram to 2 grams per 1 ounce to 10 ounces of consumable product.

In a twenty eighth aspect, the consumable product of the first aspect comprises:
a. milk;
b. cannabidiol in the amount of from 15 mg to 25 mg per 1 ounce to 10 ounces of consumable product;
c. a probiotic comprising Streptococcus thermophilus, Bacillus coagulans, Bifidobacterium breve, Bifidobacterium longum, Bifidobacterium infantis, Bifidobacterium lactis, Lactobacillus acidophilus, Lactobacillus plantarum, Lactobacillus paracasei, and Lactobacillus delbrueckii subsp. Bulgaricus at 500 billion colony forming units to 600 billion colony forming units per 1 ounce to 10 ounces of consumable product; and
d. ginger or ginger extract in the amount of from 1 gram to 2 grams per 1 ounce to 10 ounces of consumable product.

In a twenty ninth aspect, the consumable product of the twenty seventh and twenty eighth aspects further comprises a prebiotic in the amount of from 1 gram to 10 grams per 1 ounce to 10 ounces of consumable product.

In a thirtieth aspect, the consumable product of the twenty ninth aspects further comprises protein present in the amount of from 5 grams to 15 grams per 1 ounce to 10 ounces of consumable product.

In a thirty first aspect, a method for treating, preventing, or reducing one or more side effects of chemotherapy in a subject comprises the subject consuming the consumable product in the first to thirty aspects.

In a thirty second aspect, the subject in the thirty first aspects consumes the product prior to undergoing chemotherapy.

In a thirty third aspect, the subject in the thirty first aspects consumes the product during chemotherapy or after undergoing chemotherapy.

In a thirty fourth aspect, the side effects in the thirty first aspect comprise nausea, vomiting, constipation, diarrhea, inappetence, inflammation, dysbiosis of the oral cavity, dysbiosis of the gastrointestinal tract, fatigue, or any combination thereof.

In a thirty fifth aspect, a method for treating or preventing inflammation in a subject comprises consuming the consumable product in the first to thirty aspects.

In a thirty sixth aspect, the inflammation in the thirty fifth aspects comprises inflammation produced by cancer.

In a thirty seventh aspect, the cancer in the thirty sixth aspect comprises stomach cancer, colon cancer, esophageal cancer, or intestinal cancer.

In a thirty eighth aspect, the inflammation in the thirty fifth aspect comprises a gastrointenstinal disorder or a bowel disease.

In a thirty ninth aspect, the inflammation in the thirty fifth aspect is produced by inflammatory bowel disease, ulcerative colitis, Crohn's disease of the bowel, hemorrhoids, or stress ulceration of the stomach and esophagus.

In a fortieth aspect, the consumable product in the thirty fifth aspect reduces or prevents inflammation that can cause cancer.

In a forty first aspect, the inflammation in the thirty fifth aspect comprises inflammation produced by chemotherapy.

In a forty second aspect, the inflammation in the thirty fifth aspect comprises inflammation produced by diabetes.

In a forty third aspect, the inflammation in the forty second aspect comprises diabetic nephropathy, glomerulonephritis or diabetic skin ulcers.

In a forty fourth aspect, a method for reducing dysbiosis in a subject comprising the subject consuming the consumable product in the first to thirty aspects.

In a forty fifth aspect, a method for supplementing the caloric intake for a subject, comprising the subject consuming the consumable product in the first to thirty aspects.

In a forty sixth aspect, the consumable product of the forty fifth aspect constitutes a meal replacement.

In a forty seventh aspect, the consumable product of the forty fifth aspect is used for supplemental feeding.

In a forty eighth aspect, the consumable product of the thirty first to forty seventh aspects is consumed once per day.

In a forty ninth aspect, the consumable product of the thirty first to forty seventh aspects is consumed more than once per day.

Throughout this application, various publications are referenced. The disclosures of these publications in their entireties are hereby incorporated by reference into this application in order to more fully describe the compounds, compositions, and methods described herein.

Various modifications and variations can be made to the compounds, compositions, and methods described herein. Other aspects of the compounds, compositions, and methods described herein will be apparent from consideration of the specification and practice of the compounds, compositions, and methods disclosed herein. It is intended that the specification and examples be considered as exemplary.

What is claimed:

1. A frozen consumable product comprising (a) a cannabinoid, (b) a probiotic, and (c) ginger or ginger extract.

2. The consumable product of claim 1, wherein the consumable product comprises frozen yogurt, ice cream, a juice bar, or frozen ice.

3. The consumable product of claim 1, wherein the cannabinoid comprises tetrahydrocannabinol, tetrahydrocannabinolic acid, cannabidiol, cannabidiolic acid, cannabinol, cannabigerol, cannabichromene, cannabicyclol, cannabivarin, tetrahydrocannabivarin, cannabidivarin, cannabichromevarin, cannabigerovarin, cannabigerol monomethyl ether, cannabielsoin, cannabicitran, or a combination thereof.

4. The consumable product of claim 1, wherein the cannabinoid is cannabidiol.

5. The consumable product of claim 4, wherein the cannabidiol is present in an amount of from 10 mg to 30 mg per 1 ounce to 10 ounces of consumable product.

6. The consumable product of claim 1, wherein the probiotic comprises Streptococcus thermophilus, Bacillus coagulans, Bifidobacterium breve, Bifidobacterium longum, Bifidobacterium infantis, Bifidobacterium lactis, Lactobacillus acidophilus, Lactobacillus plantarum, Lactobacillus paracasei, Lactobacillus delbrueckii subsp. bulgaricus or any combination thereof.

7. The consumable product of claim 1, wherein the probiotic is present in an amount of from 100 billion colony-forming units to 900 billion colony forming units per 1 ounce to 10 ounces of consumable product.

8. The consumable product of claim 1, wherein the ginger or ginger extract is present in an amount of from 0.1 grams to 5 grams per 1 ounce to 10 ounces of consumable product.

9. The consumable product of claim 1, wherein the product further comprises a prebiotic.

10. The consumable product of claim 9, wherein the prebiotic is present in an amount of from 1 gram to 20 grams per 1 ounce to 10 ounces of consumable product.

11. The consumable product of claim 1, wherein the product further comprises a natural sweetener.

12. The consumable product of claim 1, wherein the product further comprises a protein from peas, hemp, pumpkin seeds, brown rice, soy, sunflower seeds, peanuts, quinoa, sacha inchi, chia, whey, casein, egg, alfalfa, flax, artichoke, collagen, or any combination thereof.

13. The consumable product of claim 12, wherein the protein is present in an amount of from 1 gram to 20 grams per 1 ounce to 10 ounces of consumable product.

14. The consumable product of claim 1, wherein the consumable product does not include any artificial preservatives.

15. The consumable product of claim 1, wherein the consumable product comprises:
a. fruit juice, fruit juice concentrate, fruit pulp, fruit puree, milk, or any combination thereof;
b. cannabidiol in the amount of from 15 mg to 25 mg per 1 ounce to 10 ounces of consumable product;
c. a probiotic comprising Streptococcus thermophilus, Bacillus coagulans, Bifidobacterium breve, Bifidobacterium longum, Bifidobacterium infantis, Bifidobacterium lactis, Lactobacillus acidophilus, Lactobacillus plantarum, Lactobacillus paracasei, and Lactobacillus delbrueckii subsp. Bulgaricus at 500 billion colony forming units to 600 billion colony forming units per 1 ounce to 10 ounces of consumable product; and
d. ginger or ginger extract in the amount of from 1 gram to 2 grams per 1 ounce to 10 ounces of consumable product.

16. The consumable product of claim 15, wherein the consumable product further comprises protein present in the amount of from 5 grams to 15 grams per 1 ounce to 10 ounces of consumable product.

17. A method for treating, preventing, or reducing one or more side effects of chemotherapy in a subject, the method comprising the subject consuming the consumable product of claim 1.

18. A method for treating or preventing inflammation in a subject comprising consuming the consumable product of claim 1.

19. A method for reducing dysbiosis in a subject, the method comprising the subject consuming the consumable product of claim 1.

20. A method for supplementing the caloric intake for a subject, the method comprising the subject consuming the consumable product of claim 1.
